(19) United States
(12) Patent Application Publication
(10) Pub. No.: US 2025/0269880 A1
(43) Pub. Date: Aug. 28, 2025

(54) Method and Apparatus for Controlling Vehicle

(71) Applicants: Hyundai Motor Company, Seoul (KR); Kia Corporation, Seoul (KR)

(72) Inventors: Hee Chul CHOI, Hwaseong-si (KR); Jong Hyuk LIM, Hwaseong-si (KR); Jun Hyung KIM, Hwaseong-si (KR); Da Ye OH, Hwaseong-si (KR)

(21) Appl. No.: 18/904,118

(22) Filed: Oct. 2, 2024

(30) Foreign Application Priority Data
Feb. 23, 2024 (KR) 10-2024-0026684

(51) Int. Cl. B60W 60/00; G06V 10/82; G06V 20/58

(52) U.S. Cl. CPC B60W 60/0027; G06V 10/82; G06V 20/58; B60W 2554/806

(57) ABSTRACT

A vehicle control method includes generating, using backbone associated with a neural network, a feature based on a bird's eye view (BEV) image obtained by a vehicle, generating, based on the feature and using a first neck associated with the neural network for object detection, detection information indicating a detection result for an object, generating, based on the feature and using a second neck associated with the neural network for image segmentation, a segmentation image, and controlling, based on the detection information and the segmentation image, the vehicle.

### CROSS-REFERENCE TO RELATED APPLICATION

This application claims the benefit of priority to Korean Patent Application No. 10-2024-0026684, filed in the Korean Intellectual Property Office on Feb. 23, 2024, the entire contents of which are incorporated herein by reference.

### TECHNICAL FIELD

The present disclosure relates to object detection and, more particularly, to a method and an apparatus for controlling a vehicle based on object detection.

### BACKGROUND

In recent years, as deep neural network-based computer vision technology is adopted more in the field of autonomous driving, artificial intelligence models for various driving-related tasks, such as object detection, semantic segmentation, depth map estimation, lane detection, etc., have been researched. In particular, research continues on generating detection information regarding an object by using artificial intelligence models to perform autonomous driving on the basis of the detection information. For example, a vehicle may be controlled based on the location of the other vehicle and the heading angle of the other vehicle, etc.

### SUMMARY

The present disclosure has been made to solve the above-mentioned problems occurring in at least some implementations while advantages achieved by those implementations are maintained intact.

An aspect of the present disclosure provides a method and an apparatus for controlling a vehicle by using multi-task learning.

An aspect of the present disclosure provides a method and an apparatus for determining a drivable area.

An aspect of the present disclosure provides a method and an apparatus for determining the state of a detected object according to the location of the detected object.

An aspect of the present disclosure provides a method and an apparatus for performing object detection and image segmentation by using one network.

An aspect of the present disclosure provides a method and an apparatus for performing the end-to-end learning of a neural network for object detection and image segmentation.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, a vehicle control method may include: generating, by one or more processors and using a backbone associated with a neural network, a feature based on a bird's eye view (BEV) image obtained by a vehicle; generating, based on the feature and using a first neck associated with the neural network for object detection, detection information indicating a detection result for an object; generating, based on the feature and using a second neck associated with the neural network for image segmentation, a segmentation image; and controlling, based on the detection information and the segmentation image, the vehicle.

Controlling the vehicle may include: determining, based on the segmentation image, a drivable area and a non-drivable area; and controlling, based on the detection information and information about the drivable area and the non-drivable area, the vehicle.

Controlling the vehicle may further include: determining, based on a heading angle of a first vehicle located in the drivable area, whether the first vehicle is a cross-traffic vehicle.

Controlling the vehicle further may include determining a second vehicle to be a parked vehicle based on the second vehicle being located in the non-drivable area.

Controlling the vehicle may further include: determining, based on a speed of the vehicle, a required braking distance; assigning a first risk level to a first object located in the drivable area and within the required braking distance from the vehicle; and assigning a second risk level, which is lower than the first risk level, to a second object located in the drivable area and beyond the required braking distance from the vehicle.

Controlling the vehicle may further include: assigning a first risk level to a first vehicle located in the drivable area and having a heading angle different by at least a predetermined angle from a heading angle of the vehicle; and assigning a second risk level, which is lower than the first risk level, to a second vehicle located in the drivable area and having a heading angle different by less than the predetermined angle from the heading angle of the vehicle.

Controlling the vehicle may further include: assigning a first risk level to a first pedestrian located in the drivable area; and assigning a second risk level, which is lower than the first risk level, to a second pedestrian located in the non-drivable area.

The BEV image may be obtained from a lidar mounted on the vehicle.

According to one or more example embodiments of the present disclosure, a vehicle control apparatus may include: at least one processor; and a memory. The memory may be configured to store computer-executable instructions that, when executed by the at least one processor, cause the vehicle control apparatus to: generate, using a backbone associated with a neural network, a feature based on a bird's eye view (BEV) image obtained by a vehicle; generate, based on the feature and using a first neck associated with the neural network for image detection, detection information indicating a detection result for an object; generate, based on the feature and using a second neck for image segmentation, a segmentation image; and control, based on the detection information and the segmentation image, the vehicle.

The instructions, when executed by the at least one processor, may cause the vehicle control apparatus to control the vehicle by: determining, based on the segmentation image, a drivable area and a non-drivable area; and controlling, based on the detection information and information about the drivable area and the non-drivable area, the vehicle.

The instructions, when executed by the at least one processor, may cause the vehicle control apparatus to control the vehicle by: determining, based on a heading angle of a first vehicle located in the drivable area, whether the first vehicle is a cross-traffic vehicle.

The instructions, when executed by the at least one processor, may further cause the vehicle control apparatus to determine a second vehicle to be a parked vehicle based on the second vehicle being located in the non-drivable area.

The instructions, when executed by the at least one processor, may cause the vehicle control apparatus to control the vehicle by: determining, based on a speed of the vehicle, a required braking distance; and assigning a first risk level to a first object located in the drivable area and within the required braking distance from the vehicle; and assigning a second risk level, which is lower than the first risk level, to a second object located in the drivable area and beyond the required braking distance from the vehicle.

The instructions, when executed by the at least one processor, may cause the vehicle control apparatus to control the vehicle by: assigning a first risk level to a first vehicle located in the drivable area and having a heading angle different at least by a predetermined angle from a heading angle of the vehicle; and assigning a second risk level, which is lower than the first risk level, to a second vehicle located in the drivable area and having a heading angle different by less than the predetermined angle from the heading angle of the vehicle.

The instructions, when executed by the at least one processor, may cause the vehicle control apparatus to control the vehicle by: assigning a first risk level to a first pedestrian located in the drivable area; and assigning a second risk level, which is lower than the first risk level, to a second pedestrian located in the non-drivable area.

The apparatus may further include a lidar. The BEV image may be obtained from the lidar.

### BRIEF DESCRIPTION OF THE DRAWINGS

The above and other objects, features and advantages of the present disclosure will be more apparent from the following detailed description taken in conjunction with the accompanying drawings:

FIG. 1 is a diagram illustrating a vehicle control method;

FIG. 2 is a flowchart illustrating the vehicle control method;

FIG. 3 is a flowchart illustrating the vehicle control method;

FIGS. 4A and 4B are diagrams illustrating the vehicle control method;

FIGS. 5A and 5B are diagrams illustrating the vehicle control method;

FIGS. 6A and 6B are diagrams illustrating the vehicle control method;

FIGS. 7A and 7B are diagrams illustrating the vehicle control method;

FIG. 8 is a diagram illustrating the vehicle control method;

FIG. 9 is a block diagram of a vehicle control apparatus; and

FIG. 10 is a block diagram of a computing system for executing the vehicle control method.

### DETAILED DESCRIPTION

Hereinafter, with reference to the accompanying drawings, one or more example embodiments of the present disclosure will be described in detail such that those of ordinary skill in the art may easily carry out the present disclosure. However, the present disclosure may be embodied in several different forms and is not limited to the example embodiments described herein.

In describing the example embodiments of the present disclosure, if it is determined that a detailed description of a known configuration or function may obscure the gist of the present disclosure, a detailed description thereof will be omitted. In the drawings, parts not related to the description are omitted, and like reference numerals refer to like elements throughout the specification.

In the present disclosure, it will be understood that if an element is referred to as being “connected to”, “coupled to”, or “combined with” another element, the element may be directly connected or coupled to or combined with another element or intervening elements may be present therebetween. It will be further understood that terms such as “comprise”, “include”, or “have” used in the present disclosure specify the presence of stated elements but do not preclude the presence or addition of one or more other elements.

In the present disclosure, terms such as first, second, etc. are used only for the purpose of distinguishing one element from other elements, and do not limit the order of importance of the elements unless specifically mentioned. Therefore, within the scope of the present disclosure, a first element in one example embodiment may be referred to as a second element in another example embodiment, and similarly, the second element in one example embodiment may be referred to as the first element in another example embodiment.

In the present disclosure, distinct elements are only for clearly describing their features, and do not mean that the elements are separated necessarily. That is, a plurality of elements may be integrated to form a single hardware or software unit, or a single element may be distributed to form a plurality of hardware or software units. Accordingly, such integrated or distributed example embodiments are included in the scope of the present disclosure, even if not otherwise noted.

In the present disclosure, elements described in the various example embodiments are not necessarily essential elements, and some elements may be optional. Accordingly, one or more example embodiments including a subset of the elements described in one example embodiment are also included in the scope of the present disclosure. Furthermore, example embodiments including other elements in addition to the elements described in the various example embodiments are also within the scope of this disclosure.

In the present disclosure, expressions of positional relationships used in the specification, such as top, bottom, left, or right, are described for convenience of description, and if the drawings shown in the specification are viewed in reverse, the positional relationships described in the specification may also be interpreted in the opposite way.

In the present disclosure, each of the phrases “A or B,” “at least one of A and B,” “at least one of A or B,” “A, B, or C,” “at least one of A, B, and C,” and “at least one of A, B, or C” may include any one of items listed along with a relevant phrase, or any possible combination thereof.

A detection model (e.g., a neural network) may include a backbone, a neck, and a head. The backbone may exploit the essential features of different resolutions, and the neck may fuse the features of different resolutions. At least one head may perform the detection of objects in different resolutions. The backbone network may be used in the Object detection model architectures. Backbone may be responsible for extracting and encoding features from the input data. It may act as the core feature extractor, capturing low-level and high-level features from the input data. A neck may be responsible for further transforming and refining the features extracted by the backbone model. The neck may improve the backbone's extracted features, and give more informative feature representations. The backbone may be responsible for the initial feature extraction from the input data, while the neck enhances and merge those features to improve the model's performance. The head may include task-specific layers that are designed to produce the final prediction or inference based on the information extracted by the Backbone and Neck.

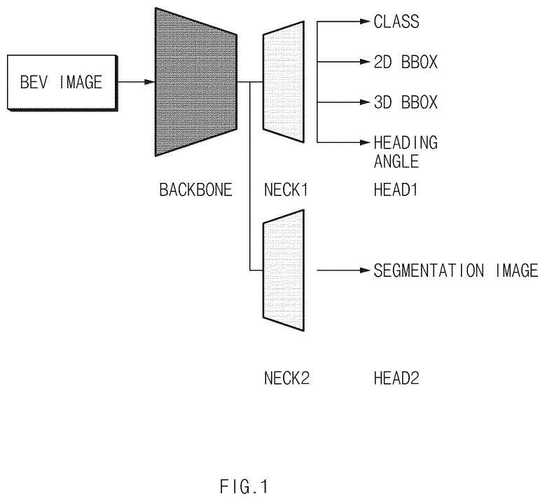

Hereinafter, the illustrative embodiments of the present disclosure will be described in detail with reference to FIGS. 1 to 10.

FIG. 1 is a diagram illustrating a vehicle control method according to an illustrative embodiment of the present disclosure;

Referring to FIG. 1, in the vehicle control method, a vehicle may be controlled by using a network including a first neck and a second neck that share a backbone. A backbone may be a network that extracts and/or encodes features from input data. A neck (e.g., a neck module) may perform multi-resolution feature aggregation. In other words, in the vehicle control method, a vehicle may be controlled by using a network capable of performing multi-task learning. Specifically, the first neck regarding object detection and the second neck regarding image segmentation may share the backbone. In the vehicle control method, a feature may be generated on the basis of a bird's eye view (BEV) image through the backbone. A bird's-eye view may be a view taken above a certain distance from a ground and/or an object and may capture an area larger than a threshold (e.g., a threshold area configured in memory of the aerial vehicle). A bird's-eye view image may indicate (and/or may be associated with) a perspective angle from the aerial vehicle (e.g., row, yaw, pitch information of the aerial vehicle and/or one or more cameras of the aerial vehicle). A bird's-eye view image may indicate (and/or may be associated with) time information and/or other indicators of a frame of the bird's-eye view image. A bird's-eye view image may indicate (and/or may be associated with) one or more landmark images included in the bird's-eye view image. The BEV image may be obtained from a lidar, but this is not limited thereto. In addition, in the vehicle control method, detection information indicating a detection result for an object on the basis of the feature may be generated through the first neck regarding the object detection. For example, the detection information may include information about the position of an object, information about the class of the object, information about the 2D bounding box of the object, information about the 3D bounding box of the object, information about the heading angle of the object, etc. In addition, in the vehicle control method, a segmentation image may be generated on the basis of the feature through the second neck regarding the image segmentation. In the vehicle control method, multi-task learning may be performed by using the necks that share the backbone.

In the vehicle control method, the vehicle may be controlled on the basis of the detection information and the segmentation image which are generated. Details regarding the method of controlling the vehicle on the basis of the detection information and the segmentation image will be described later.

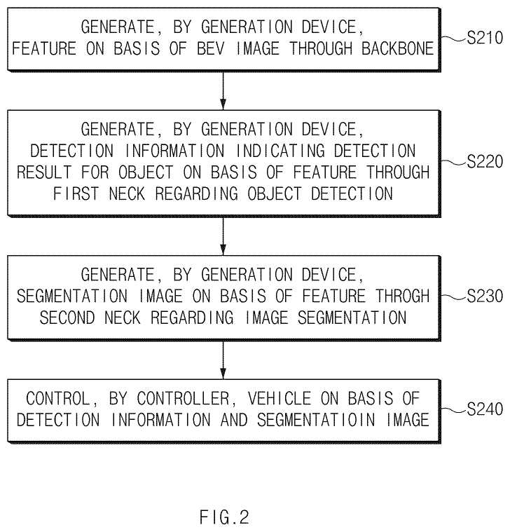

FIG. 2 is a flowchart illustrating the vehicle control method.

Referring to FIG. 2, according to the vehicle control method, in S210, a generation device may generate the feature on the basis of a BEV image through the backbone.

According to the vehicle control method, in S220, the generation device may generate the detection information indicating a detection result for an object on the basis of the feature through the first neck regarding the object detection. For example, in the vehicle control method, information about the location of an object, information about the class of the object, information about the 2D bounding box of the object, information about the 3D bounding box of the object, and information about the heading angle of the object, etc. may be generated on the basis of the feature through the first neck.

According to the vehicle control method, in S230, the generation device may generate the segmentation image on the basis of the feature through the second neck regarding the image segmentation. The first neck and the second neck may share the backbone. In other words, in the vehicle control method, it is possible to perform the object detection and the image segmentation which are two tasks by using one network.

According to the vehicle control method, in S240, a controller may control the vehicle on the basis of the detection information and the segmentation image. Details regarding the method of controlling the vehicle on the basis of the detection information and the segmentation image will be described later.

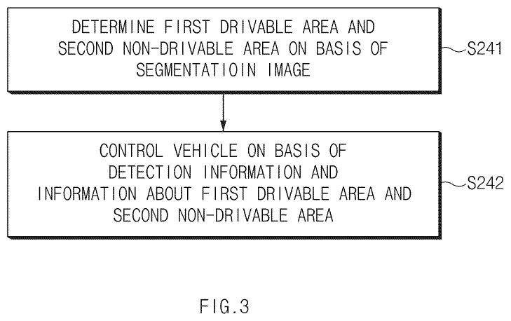

FIG. 3 is a flowchart illustrating the vehicle control method. S241 and S242 of FIG. 3 may correspond to S240 of FIG. 2.

Referring to FIG. 3, in S241, a first drivable area and a second non-drivable area may be determined on the basis of the segmentation image. For example, on the basis of the segmentation image, an area recognized as a road may be determined as the first drivable area, and the other areas may be determined as the second non-drivable area, but this is not limited thereto.

According to the vehicle control method, in S242, a vehicle may be controlled on the basis of the detection information and information about the first drivable area and the second non-drivable area. For example, if a vehicle detected ahead is in the first drivable area, and a difference between the heading angle of a host vehicle and the heading angle of the vehicle detected ahead is within a predetermined angle range, the vehicle detected ahead may be determined as a turning and entering vehicle (e.g., a cross-traffic vehicle). In addition, in the vehicle control method, the vehicle determined as the turning and entering vehicle (e.g., a cross-traffic vehicle) may be set as a high-risk vehicle. In addition, if a vehicle detected ahead is in the second non-drivable area, the vehicle may be determined as a parked vehicle in the vehicle control method. In addition, in the vehicle control method, the parked vehicle may be set as a vehicle with lower risk than the turning and entering vehicle (e.g., a cross-traffic vehicle). More details of controlling the vehicle on the basis of the detection information and the information about the first drivable area and the second non-drivable area will be described later.

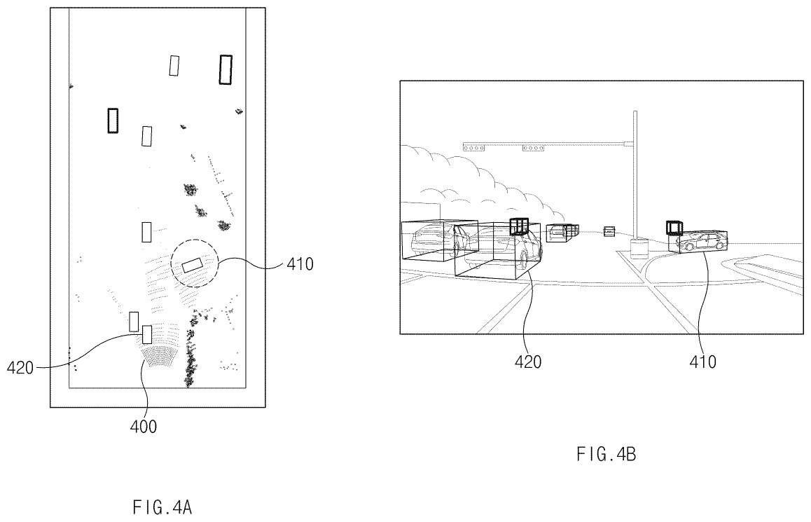

FIGS. 4A and 4B are diagrams illustrating the vehicle control method. FIG. 4A is an image illustrating detected objects 410 and 420 and the determined drivable area 400 on the basis of a BEV image. In addition, FIG. 4B is an image generated by projecting the BEV image into an image coordinate system.

Referring to FIG. 4, in the vehicle control method, it may be determined whether a detected vehicle is located in the first drivable area or the second non-drivable area and whether the vehicle is the turning and entering vehicle (e.g., a cross-traffic vehicle) on the basis of the heading angle of the vehicle. For example, in the vehicle control method, it may be determined whether detected vehicles 410 and 420 are located in the drivable area 400. Since the vehicle 410 and the vehicle 420 are all located in the drivable area 400, the vehicle 410 and the vehicle 420 may be vehicles that are driving or vehicles that are ready to drive.

In addition, in the vehicle control method, it may be determined whether each of the detected vehicles 410 and 420 is a turning and entering vehicle (e.g., a cross-traffic vehicle) or a preceding vehicle on the basis of the heading angles of the detected vehicles 410 and 420. For example, it may be assumed that the heading angle of the vehicle 410 is different from the heading angle of a host vehicle by an angle equal to less than a threshold. According to the vehicle control method, in this case, the vehicle 410 may be determined as a preceding vehicle. In addition, in the vehicle control method, if a difference between the heading angle of the vehicle 410 and the heading angle of a host vehicle is within a predetermined angle range, the vehicle 410 may be determined as the turning and entering vehicle (e.g., a cross-traffic vehicle).

In the vehicle control method, a higher risk may be set for the turning and entering vehicle (e.g., a cross-traffic vehicle) 410 than for the preceding vehicle 420, but this is not limited thereto. In the vehicle control method, autonomous driving may be performed on the basis of a set (e.g., assigned, assessed) risk level.

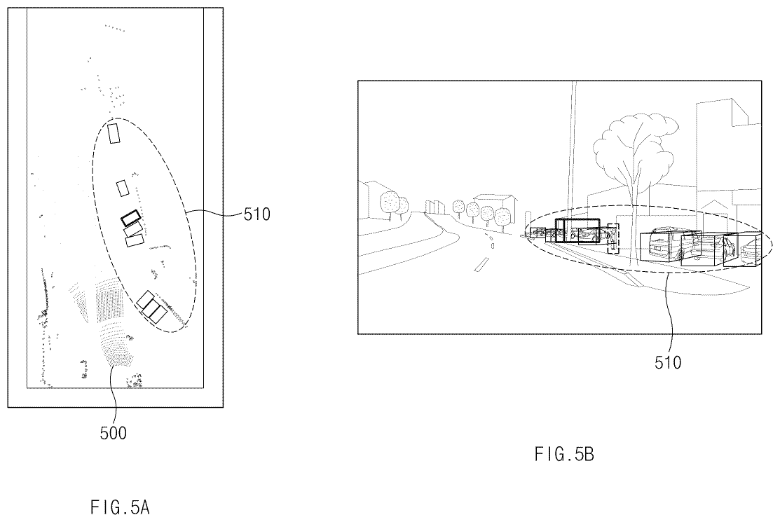

FIGS. 5A and 5B are diagrams illustrating the vehicle control method. FIG. 5A is an image illustrating detected vehicles 510 and a determined drivable area 500 on the basis of a BEV image. In addition, FIG. 5B is an image generated by projecting the BEV image into the image coordinate system.

Referring to FIGS. 5A and 5B, in the vehicle control method, it may be determined whether the detected vehicles 510 are parked vehicles depending on whether the detected vehicles 510 are in the drivable area 500. For example, in the vehicle control method, since the detected vehicles 510 are not in the drivable area 500 but in a non-drivable area, the vehicles 510 located in the non-drivable area may be determined as parked vehicles. In the vehicle control method, a vehicle may be controlled by setting (e.g., assigning) a lower risk level for the parked vehicles 510 than the vehicle driving in the drivable area 500.

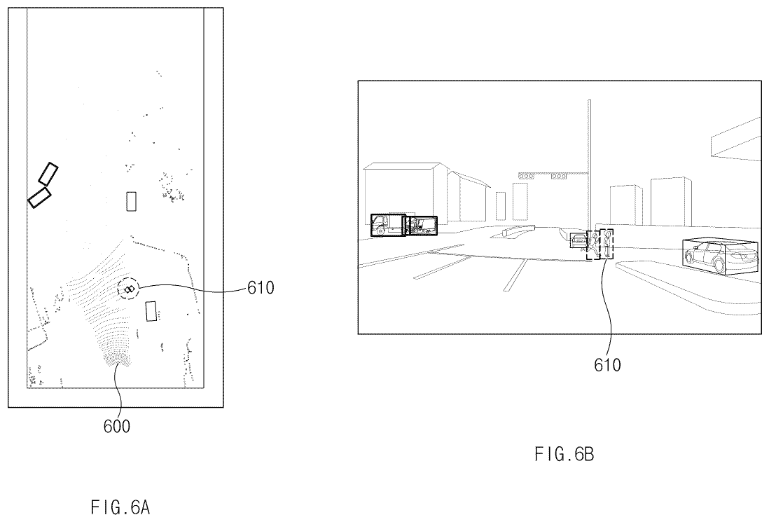

FIGS. 6A and 6B are diagrams illustrating the vehicle control method. FIG. 6A is an image illustrating detected objects 610 and a determined drivable area 600 on the basis of a BEV image. In addition, FIG. 6B is an image generated by projecting the BEV image into the image coordinate system.

Referring to FIGS. 6A and 6B, in the vehicle control method, a vehicle may be controlled by determining whether the detected pedestrians 610 are in the drivable area 600. For example, in the vehicle control method, since the detected pedestrians 610 are in the drivable area 500, the vehicle may be controlled by setting (e.g., assigning) a relatively high risk level for the pedestrians 610. For example, in the vehicle control method, a vehicle may be controlled by setting a higher risk level for the pedestrians 610 in the drivable area 600 than for a pedestrian in the non-drivable area.

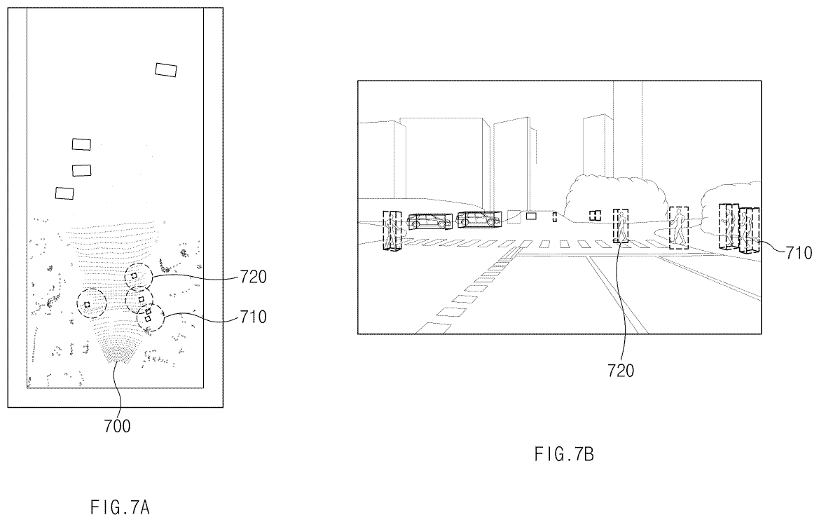

FIGS. 7A and 7B are diagrams illustrating the vehicle control method. FIG. 7A is an image illustrating detected objects 710 and 720 and a determined drivable area 700 on the basis of a BEV image. In addition, FIG. 7B is an image generated by projecting the BEV image into the image coordinate system.

Referring to FIGS. 7A and 7B, in the vehicle control method, a vehicle may be controlled by determining whether the detected pedestrians 710 and 720 are in the drivable area 700. For example, in the vehicle control method, since the detected pedestrians 720 are in the drivable area 500, the vehicle may be controlled by setting a relatively high risk level for the pedestrians 720. In addition, in the vehicle control method, since the detected pedestrians 710 are in the non-drivable area, the vehicle may be controlled by setting a relatively low risk level for the pedestrians 710. For example, in the vehicle control method, the vehicle may be controlled by setting a higher risk level for the pedestrians 720 in the drivable area 700 than for the pedestrians 710 in the non-drivable area.

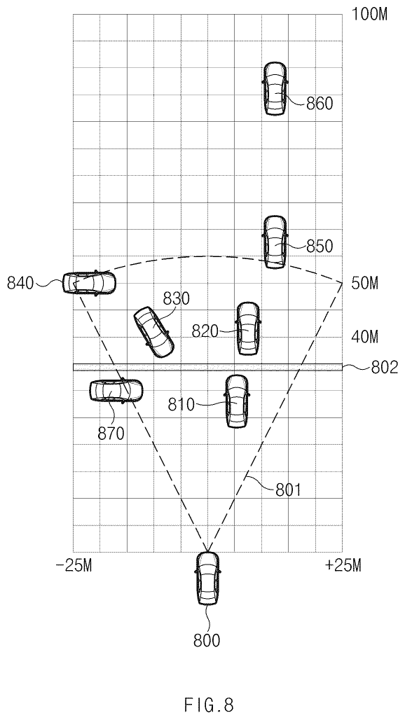

FIG. 8 is a diagram illustrating the vehicle control method.

Referring to FIG. 8, in the vehicle control method, objects 810 to 870 may be detected. In addition, in the vehicle control method, a drivable area and a non-drivable area may be determined within a range 801 for determining whether an area is the drivable area. In addition, in the vehicle control method, a vehicle may be controlled by setting a risk level for the detected objects 810 to 870. Specifically, in the vehicle control method, a required braking distance 802 may be calculated on the basis of the speed of a host vehicle 800. The required braking distance 802 may refer to a total distance required to completely stop the vehicle 800. Specifically, the required braking distance 802 may be the sum of a reaction distance and a braking distance. If the required braking distance 802 is 35 m, a relatively high risk may be set for each of the vehicles 810 and 870 included within the required braking distance of 35 m from the vehicle 800. In the vehicle control method, if the vehicle 870 is in the non-drivable area, the vehicle 870 may be determined as a parked vehicle. In addition, in the vehicle control method, if the vehicle 810 is in the drivable area, the vehicle 810 may be recognized as a preceding vehicle. In addition, in the vehicle control method, a higher risk level may be set for the vehicle 810 in the drivable area than for the parked vehicle 870.

In the vehicle control method, a lower risk may be set for each of the vehicles 820 to 860 located farther than the required braking distance 802 than for the vehicle 810 located within the required braking distance 802. In addition, in the vehicle control method, the farther away the vehicle is from the host vehicle 800, the lower risk level may be set, but this is not limited thereto. For example, the vehicle 860 may be lower in a risk level than the vehicle 850, but this is not limited thereto.

In the vehicle control method, among the vehicles in the drivable area, the vehicles 830 and 840 having heading angles different by a predetermined angle or more from the heading angle of the vehicle 800 may be determined as turning and entering vehicles (e.g., a cross-traffic vehicles or oncoming vehicles). In addition, in the vehicle control method, a higher risk may be set for each of the turning and entering vehicles (e.g., a cross-traffic vehicles or oncoming vehicles) 830 and 840 than for the preceding vehicles 810, 820, 850, and 860, but this is not limited thereto.

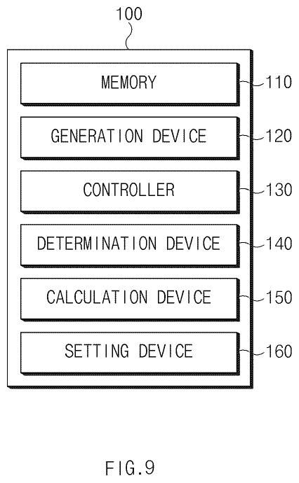

FIG. 9 is a block diagram of a vehicle control apparatus.

Referring to FIG. 9, a vehicle control apparatus 100 may include a memory 110, a generation device 120, a controller 130, a determination device 140, a calculation device 150, and a setting device 160. The generation device 120, the controller 130, the determination device 140, the calculation device 150, and the setting device 160 may correspond to a processor.

The memory 110 may be configured to store computer-executable instructions.

The processor may be configured to access the memory 110 and execute the instructions.

The vehicle control apparatus 100 may generate a feature on the basis of a BEV image by using the backbone through the generation device 120. The BEV image may be obtained from a lidar, but is not limited thereto. In addition, the vehicle control apparatus 100 may generate the detection information indicating a detection result for an object on the basis of the feature by using the first neck regarding object detection through the generation device 120. In addition, the vehicle control apparatus 100 may generate the segmentation image on the basis of the feature by using the second neck regarding image segmentation through the generation device 120.

The vehicle control apparatus 100 may be configured to control a vehicle on the basis of the detection information and the segmentation image through the controller 130. In other words, the vehicle control apparatus 100 may control a vehicle by using a network including the first neck and the second neck sharing the backbone.

The vehicle control apparatus 100 may determine, through the determination device 140, the first drivable area and the second non-drivable area on the basis of the segmentation image. In addition, the vehicle control apparatus 100 may control a vehicle on the basis of the detection information and information about the first drivable area and the second non-drivable area through the controller 130.

The vehicle control apparatus 100 may determine, through the determination device 140, whether the first vehicle is the turning and entering vehicle (e.g., a cross-traffic vehicles) on the basis of the heading angle of a first vehicle located in the first drivable area. In addition, the vehicle control apparatus 100 may determine, through the determination device 140, a second vehicle as a parked vehicle if the second vehicle is located in the second non-drivable area.

The vehicle control apparatus 100 may calculate, through the calculation device 150, the required braking distance on the basis of the speed of a vehicle. In addition, the vehicle control apparatus 100 may set, through the setting device 160, a first object in the first drivable area and located closer than the required braking distance from the vehicle as having a first risk level. In addition, the vehicle control apparatus 100 may set, through the setting device 160, a second object in the first drivable area and located farther than the required braking distance from the vehicle as having a second risk level lower than the first risk level.

The vehicle control apparatus 100 may set, through the setting device 160, a third vehicle located in the first drivable area and having a heading angle different by a predetermined angle or more from the heading angle of the vehicle as having a third risk level. In addition, the vehicle control apparatus 100 may set, through the setting device 160, a fourth vehicle located in the first drivable area and having a heading angle different by less than a predetermined angle from the heading angle of the vehicle as having a fourth risk level lower than the third risk level.

The vehicle control apparatus 100 may set, through the setting device 160, a first pedestrian in the first drivable area as having a fifth risk level. In addition, the vehicle control apparatus 100 may set, through the setting device 160, a second pedestrian located in the second non-drivable area as having a sixth risk level lower than the fifth risk level.

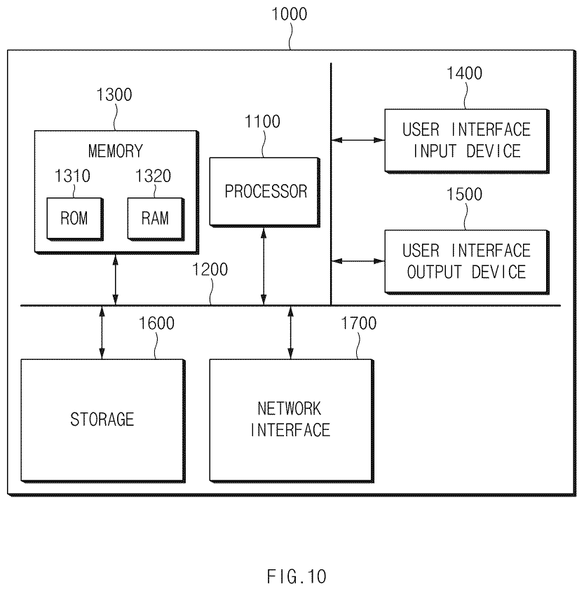

FIG. 10 is a block diagram of a computing system for executing the vehicle control method.

Referring to FIG. 10, the above-described vehicle control method may be implemented through the computing system. A computing system 1000 may include at least one processor 1100, a memory 1300, a user interface input device 1400, a user interface output device 1500, storage 1600, and a network interface 1700 connected through a system bus 1200.

The processor 1100 may be a central processing unit (CPU) or a semiconductor device that processes instructions stored in the memory 1300 and/or the storage 1600.

The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described herein may be implemented directly with hardware or software modules executed by the processor 1100, or with a combination thereof. The software module may reside in a storage medium (i.e., the memory 1300 and/or the storage 1600), such as RAM, a flash memory, a ROM, an EPROM, an EEPROM, a register, a hard disk, a removable disk, or a CD-ROM. The exemplary storage medium may be coupled to the processor 1100, wherein the processor 1100 may read information from the storage medium and write information to the storage medium. Alternatively, the storage medium may be integrated with the processor 1100. The processor 1100 and the storage medium may reside within an application specific integrated circuit (ASIC). The ASIC may reside within a user terminal. Alternatively, the processor 1100 and the storage medium may reside as separate components within a user terminal.

The above description is merely illustrative of the technical idea of the present disclosure, and various modifications and variations may be made without departing from the essential characteristics of the present disclosure by those skilled in the art to which the present disclosure pertains. Accordingly, the present disclosure is not intended to limit the technical idea of the present disclosure but to describe the present disclosure, and the scope of the technical idea of the present disclosure is not limited by the one or more example embodiments. The scope of protection of the present disclosure should be interpreted by the following claims, and all technical ideas within the scope equivalent thereto should be construed as being included in the scope of the present disclosure.

According to an aspect of the present disclosure, a vehicle control method according to an illustrative embodiment of the present disclosure includes generating, by a generation device, a feature on a basis of a bird's eye view (BEV) image through a backbone, generating, by the generation device, detection information indicating a detection result for an object on a basis of the feature through a first neck regarding object detection, generating, by the generation device, a segmentation image on the basis of the feature through a second neck regarding image segmentation, and controlling, by a controller, a vehicle on a basis of the detection information and the segmentation image.

According to an embodiment, the controlling of the vehicle may include determining, by a determination device, a first drivable area and a second non-drivable area on a basis of the segmentation image, and controlling, by the controller, the vehicle on a basis of the detection information and information about the first drivable area and the second non-drivable area.

According to an embodiment, the controlling of the vehicle may further include determining, by the determination device, whether a first vehicle is a turning and entering vehicle on a basis of a heading angle of the first vehicle located in the first drivable area.

According to an embodiment, the controlling of the vehicle may further include determining, by the determination device, a second vehicle as a parked vehicle if the second vehicle is located in the second non-drivable area.

According to an embodiment, the controlling of the vehicle may further include calculating, by a calculation device, a required braking distance on a basis of a speed of the vehicle, setting, by a setting device, a first object in the first drivable area and located closer than the required braking distance from the vehicle as having a first risk level, and setting, by the setting device, a second object in the first drivable area and located farther than the required braking distance from the vehicle as having a second risk level lower than the first risk level.

According to an embodiment, the controlling of the vehicle may further include setting, by the setting device, a third vehicle located in the first drivable area and having a heading angle different by a predetermined angle or more from a heading angle of the vehicle as having a third risk level, and setting, by the setting device, a fourth vehicle located in the first drivable area and having a heading angle different by less than the predetermined angle from the heading angle of the vehicle as having a fourth risk level lower than the third risk level.

According to an embodiment, the controlling of the vehicle may further include setting, by a setting device, a first pedestrian located in the first drivable area as having a fifth risk level, and setting, by the setting device, a second pedestrian located in the second non-drivable area as having a sixth risk level lower than the fifth risk level.

According to an embodiment, the BEV image may be obtained from a lidar.

According to an aspect of the present disclosure, a vehicle control apparatus according to an illustrative embodiment of the present disclosure includes a memory that stores computer-executable instructions, and at least one processor that accesses the memory and executes the instructions, wherein the at least one processor generates, through a generation device, the feature on a basis of a bird's eye view (BEV) image by using the backbone, generates, through the generation device, detection information indicating a detection result for an object on a basis of the feature by using the first neck regarding object detection, and generates, through the generation device, a segmentation image on the basis of the feature by using the second neck regarding image segmentation, and controls, through the controller, a vehicle on a basis of the detection information and the segmentation image.

According to an embodiment, the at least one processor may determine, through a determination device, the first drivable area and the second non-drivable area on the basis of the segmentation image, and control, through the controller, the vehicle on the basis of the detection information and information about the first drivable area and the second non-drivable area.

According to an embodiment, the at least one processor may determine, through the determination device, whether the first vehicle is a turning and entering vehicle on the basis of a heading angle of the first vehicle located in the first drivable area.

According to an embodiment, the at least one processor may determine, through the determination device, the second vehicle as a parked vehicle if the second vehicle is located in the second non-drivable area.

According to an embodiment, the at least one processor may calculate, through a calculation device, a required braking distance on the basis of the speed of the vehicle, and set, through a setting device, the first object in the first drivable area and located closer than the required braking distance from the vehicle as having a first risk level, and set, through the setting device, the second object in the first drivable area and located farther than the required braking distance from the vehicle as having a second risk level lower than the first risk level.

According to an embodiment, the at least one processor may set, through a setting device, a third vehicle located in the first drivable area and having a heading angle different by a predetermined angle or more from a heading angle of the vehicle as having a third risk level, and set, through the setting device, a fourth vehicle located in the first drivable area and having a heading angle different by less than the predetermined angle from the heading angle of the vehicle as having a fourth risk level lower than the third risk level.

According to an embodiment, the at least one processor may set, through a setting device, a first pedestrian located in the first drivable area as having a fifth risk level and set, through the setting device, a second pedestrian located in the second non-drivable area as having a sixth risk level lower than the fifth risk level.

According to an embodiment, the BEV image may be obtained from the lidar.

The features briefly summarized above for the present disclosure are only illustrative aspects of the detailed description of the disclosure that follows, but do not limit the scope of the present disclosure.

According to the vehicle control method according to the illustrative embodiment of the present disclosure, it is possible to control a vehicle by using multi-task learning.

According to the vehicle control method according to the illustrative embodiment of the present disclosure, it is possible to determine a drivable area.

According to the vehicle control method according to the illustrative embodiment of the present disclosure, it is possible to determine the state of a detected object according to the location of the object.

According to the vehicle control method according to the illustrative embodiment of the present disclosure, it is possible to perform object detection and image segmentation by using one network.

In the vehicle control method according to the illustrative embodiment of the present disclosure, it is possible to perform the end-to-end learning of a neural network for object detection and image segmentation.

The effects obtainable in the present disclosure are not limited to the aforementioned effects, and any other effects not mentioned herein will be clearly understood from the following description by those skilled in the art to which the present disclosure pertains.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A vehicle control method comprising:
generating, by one or more processors and using a backbone associated with a neural network, a feature based on a bird's eye view (BEV) image obtained by a vehicle;
generating, based on the feature and using a first neck associated with the neural network for object detection, detection information indicating a detection result for an object;
generating, based on the feature and using a second neck associated with the neural network for image segmentation, a segmentation image; and
controlling, based on the detection information and the segmentation image, the vehicle.

2. The method of claim 1, wherein the controlling of the vehicle comprises:
determining, based on the segmentation image, a drivable area and a non-drivable area; and
controlling, based on the detection information and information about the drivable area and the non-drivable area, the vehicle.

3. The method of claim 2, wherein the controlling of the vehicle further comprises:
determining, based on a heading angle of a first vehicle located in the drivable area, whether the first vehicle is a cross-traffic vehicle.

4. The method of claim 2, wherein the controlling of the vehicle further comprises determining a second vehicle to be a parked vehicle based on the second vehicle being located in the non-drivable area.

5. The method of claim 2, wherein the controlling of the vehicle further comprises:
determining, based on a speed of the vehicle, a required braking distance;
assigning a first risk level to a first object located in the drivable area and within the required braking distance from the vehicle; and
assigning a second risk level, which is lower than the first risk level, to a second object located in the drivable area and beyond the required braking distance from the vehicle.

6. The method of claim 2, wherein the controlling of the vehicle further comprises:
assigning a first risk level to a first vehicle located in the drivable area and having a heading angle different by at least a predetermined angle from a heading angle of the vehicle; and
assigning a second risk level, which is lower than the first risk level, to a second vehicle located in the drivable area and having a heading angle different by less than the predetermined angle from the heading angle of the vehicle.

7. The method of claim 2, wherein the controlling of the vehicle further comprises:
assigning a first risk level to a first pedestrian located in the drivable area; and
assigning a second risk level, which is lower than the first risk level, to a second pedestrian located in the non-drivable area.

8. The method of claim 1, wherein the BEV image is obtained from a lidar mounted on the vehicle.

9. A vehicle control apparatus comprising:
at least one processor; and
a memory configured to store computer-executable instructions that, when executed by the at least one processor, cause the vehicle control apparatus to:
generate, using a backbone associated with a neural network, a feature based on a bird's eye view (BEV) image obtained by a vehicle;
generate, based on the feature and using a first neck associated with the neural network for image detection, detection information indicating a detection result for an object;
generate, based on the feature and using a second neck for image segmentation, a segmentation image; and
control, based on the detection information and the segmentation image, the vehicle.

10. The apparatus of claim 9, wherein the instructions, when executed by the at least one processor, cause the vehicle control apparatus to control the vehicle by:
determining, based on the segmentation image, a drivable area and a non-drivable area; and
controlling, based on the detection information and information about the drivable area and the non-drivable area, the vehicle.

11. The apparatus of claim 10, wherein the instructions, when executed by the at least one processor, cause the vehicle control apparatus to control the vehicle by:
determining, based on a heading angle of a first vehicle located in the drivable area, whether the first vehicle is a cross-traffic vehicle.

12. The apparatus of claim 10, wherein the instructions, when executed by the at least one processor, further cause the vehicle control apparatus to determine a second vehicle to be a parked vehicle based on the second vehicle being located in the non-drivable area.

13. The apparatus of claim 10, wherein the instructions, when executed by the at least one processor, cause the vehicle control apparatus to control the vehicle by:
determining, based on a speed of the vehicle, a required braking distance; and
assigning a first risk level to a first object located in the drivable area and within the required braking distance from the vehicle; and
assigning a second risk level, which is lower than the first risk level, to a second object located in the drivable area and beyond the required braking distance from the vehicle.

14. The apparatus of claim 10, wherein the instructions, when executed by the at least one processor, cause the vehicle control apparatus to control the vehicle by:
assigning a first risk level to a first vehicle located in the drivable area and having a heading angle different at least by a predetermined angle from a heading angle of the vehicle; and
assigning a second risk level, which is lower than the first risk level, to a second vehicle located in the drivable area and having a heading angle different by less than the predetermined angle from the heading angle of the vehicle.

15. The apparatus of claim 10, wherein the instructions, when executed by the at least one processor, cause the vehicle control apparatus to control the vehicle by:
assigning a first risk level to a first pedestrian located in the drivable area; and
assigning a second risk level, which is lower than the first risk level, to a second pedestrian located in the non-drivable area.

16. The apparatus of claim 13, wherein the apparatus further comprises a lidar, and wherein the BEV image is obtained from the lidar.
